(19) United States
(12) Patent Application Publication
(10) Pub. No.: US 2022/0127409 A1
(43) Pub. Date: Apr. 28, 2022

(54) LOW-DENSITY VISCOELASTIC FOAMS, BODY SUPPORT ARTICLES COMPRISING SAME, AND METHODS FOR MAKING SAME

(71) Applicant: SINOMAX USA INC., Houston, TX (US)

(72) Inventors: Ellee Elchaer, Nashville, TN (US); John Beliveau, Mooresville, NC (US)

(73) Assignee: SINOMAX USA INC., Houston, TX (US)

(21) Appl. No.: 17/508,817

(22) Filed: Oct. 22, 2021

Related U.S. Application Data
(60) Provisional application No. 63/104,835, filed on Oct. 23, 2020.

(51) Int. Cl. C08G 18/48; C08G 18/76; C08G 18/63; C08G 18/08; C08G 18/18

(52) U.S. Cl. CPC C08G 18/4829; C08G 18/7621; C08L 83/04; C08G 18/14; C08G 18/18; C08G 18/633

(57) ABSTRACT

A viscoelastic foam layer, comprising a polyurethane comprising: from about 15 weight parts to about 75 weight parts toluene diisocyanate (TDI) residues per 100 weight parts polyol residues; wherein the viscoelastic foam layer: has a density less than or equal to 2 pounds/cubic foot (0.032 g/cm³), has an air flow greater than or equal to 2.5 CFM (0.07 m³/min), has a recovery time greater than or equal to 4 seconds, has an indentation force deflection (IFD) less than or equal to 10 pounds/square foot (478.8 Pa), has a height loss less than or equal to 10% after prolonged compression of 90% of an original height. A method of making the viscoelastic foam layer. A body support article comprising the viscoelastic foam layer.

### BACKGROUND OF THE INVENTION

### Field of the Invention

Generally, the present disclosure relates to body support articles, such as mattresses, and, more specifically, to body support devices formed from low-density viscoelastic foams.

### Description of the Related Art

Foam mattresses, such as viscoelastic or so-called “memory foam” mattresses, have grown rapidly in market share since the turn of the century. Viscoelastic foam layers in such mattresses are commonly formed by combining an isocyanate, such as toluene diisocyanate (TDI) or methylene diisocyanate (MDI), with one or more polyols. One of the convenient aspects of foam mattresses that has encouraged their adoption by consumers is the compressibility and re-expandability of viscoelastic foam layers, thereby allowing “bed in a box” product packaging, in which a consumer may order a viscoelastic foam mattress online and have it shipped using standard consumer shipping avenues (UPS USPS, etc.), which is impossible for conventional metal coil mattresses and accompanying box springs.

However, to meet consumer expectations regarding compressibility and re-expandability, viscoelastic foam manufacturers have turned away from TDI in favor of MDI. Specifically, viscoelastic foam mattresses comprising TDI as the primary isocyanate component in the viscoelastic foam layer, especially viscoelastic foam layers having a density less than or equal to 2 pounds/cubic foot (0.032 g/cm³), generally cannot have both an air flow greater than or equal to 2.5 CFM (0.07 m³/min) and a recovery time greater than or equal to 4 seconds and/or generally cannot have both an indentation force deflection (IFD) less than or equal to 10 pounds/square foot (478.8 Pa), and a height loss less than or equal to 10% after prolonged compression of 90% of an original height.

Accordingly, it would be desirable to have a viscoelastic foam layer comprising TDI as the primary isocyanate component and one or both of the pairs of properties not heretofore seen in TDI mattresses.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

In one embodiment, the present disclosure is directed to a viscoelastic foam layer, comprising a polyurethane, comprising from about 15 weight parts to about 75 weight parts toluene diisocyanate (TDI) residues per 100 weight parts polyol residues; wherein the viscoelastic foam layer: has a density less than or equal to 2 pounds/cubic foot (0.032 g/cm³), has an air flow greater than or equal to 2.5 CFM (0.07 m³/min) (cubic feet/minute), has a recovery time greater than or equal to 4 seconds, has an indentation force deflection (IFD) less than or equal to 10 pounds/square foot (478.8 Pa), and has a height loss less than or equal to 10% after prolonged compression of 90% of an original height.

In one embodiment, the present disclosure is directed to a body support article, comprising a viscoelastic foam layer as described above.

In one embodiment, the present disclosure is directed to a method, comprising mixing, at a temperature from about 60° F. (15° C.) to about 80° F. (27° C.), a mixer head pressure from about 8 psi (55 kPa) to about 15 psi (104 kPa), and a shear mixing velocity from about 2500 rpm to about 5000 rpm, at least one polyol to yield a first mixture; and injecting into the first mixture, at a pressure from about 300 psi (2.06 MPa) to about 500 psi (3.45 MPa), from about 15 weight parts to about 75 weight parts toluene diisocyanate (TDI) residues per 100 weight parts polyol residues, to form a viscoelastic foam layer.

The present disclosure may provide for viscoelastic foam layers that (a) comprise TDI, such as 80/20 or 65/35 TDI, as the primary isocyanate and (b) provide desired combinations of comfort and transportability. In particular, the present disclosure may provide for viscoelastic foam layers that (a) comprise TDI, such as 80/20 or 65/35 TDI, as the primary isocyanate and (b) have both (i) an air flow greater than or equal to 2.5 CFM (0.07 m³/min) and a recovery time greater than or equal to 4 seconds and/or (ii) an IFD less than or equal to 10 pounds/square foot (478.8 Pa), and a height loss less than or equal to 10% after prolonged compression of 90% of an original height.

### BRIEF DESCRIPTION OF THE DRAWINGS

The disclosure may be understood by reference to the following description taken in conjunction with the accompanying drawings, in which like reference numerals identify like elements, and in which:

FIG. 1 presents a flowchart of a method, in accordance with embodiments herein.

FIG. 2 depicts a stylized top view of a mattress, in accordance with embodiments herein.

FIG. 3 depicts a stylized side view of a mattress, in accordance with embodiments herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION

Various illustrative embodiments of the disclosure are described below. In the interest of clarity, not all features of an actual implementation are described in this specification. It will, of course, be appreciated that, in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The present subject matter will now be described with reference to the attached figures. Various structures, systems and devices are conceptually depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments herein may provide viscoelastic foam layers, particular low density (<2 pounds/cubic foot) viscoelastic foam layers, comprising toluene diisocyanate (TDI) that have various properties, such as both high air flow and long recovery times, and/or both a low indentation force deflection (IFD) and a low recovery height loss, that have not previously been observed for low density foams comprising TDI.

In one embodiment, the present disclosure relates to a viscoelastic foam layer, comprising a polyurethane, comprising from about 15 weight parts to about 75 weight parts toluene diisocyanate (TDI) residues per 100 weight parts polyol residues; wherein the viscoelastic foam layer: has a density less than or equal to 2 pounds/cubic foot (0.032 g/cm³), has an air flow greater than or equal to 2.5 CFM (0.07 m³/min) (cubic feet/minute), has a recovery time greater than or equal to 4 seconds, has an indentation force deflection (IFD) less than or equal to 10 pounds/square foot (478.8 Pa), and has a height loss less than or equal to 10% after prolonged compression of 90% of an original height.

The viscoelastic foam layer is generally as known in the art. Typically, the viscoelastic foam layer comprises an open-celled non-reticulated viscoelastic foam (sometimes referred to as “memory foam” or “low resilience foam”).

Generally, viscoelastic foams may be formed by preparing a first mixture, typically comprising one or more polyols, followed by foaming the first mixture with an isocyanate, to yield a polyurethane polymer comprising polyol residues and isocyanate residues. The present inventors have discovered that viscoelastic foams having unexpected properties can surprisingly be generated by using toluene diisocyanate (TDI) as the isocyanate.

A polyol is an organic compound containing more than one hydroxyl groups. Any polyol may be used. If multiple polyols are used, any relative proportions thereof may be used. Polyols range from very small molecules, such as methylene oxide, ethylene oxide, and propylene oxide, to long-chain and or polymeric compounds having molecular weights in the thousands or tens of thousands of Da.

In one embodiment, the polyol residues comprise (a) from about 5 weight parts to about 25 weight parts of polyol residues of a polyether triol with a molecular weight of about 4600 Da and a high ethylene oxide content per 100 weight parts total polyol residues, and (b) from about 5 weight parts to about 15 weight parts of polyol residues of a grafted copolymer triol comprising styrene and acrylonitrile per 100 weight parts total polyol residues.

In another embodiment, the polyol residues comprise (a) from about 5 weight parts to about 15 weight parts of polyol residues of a glycerin-initiate heteropolymer triol with a molecular weight of about 3100 Da per 100 weight parts total polyol residues, and (b) from about 5 weight parts to about 60 weight parts of polyol residues of a polyether triol with a molecular weight of about 1000 Da per 100 weight parts total polyol residues.

In an additional embodiment, the polyol residues comprise (a) from about 5 weight parts to about 15 weight parts of polyol residues of a glycerin-initiate heteropolymer triol with a molecular weight of about 3100 Da per 100 weight parts total polyol residues, (b) from about 5 weight parts to about 25 weight parts of polyol residues of a polyether triol with a molecular weight of about 4600 Da and a high ethylene oxide content per 100 weight parts total polyol residues, (c) from about 5 weight parts to about 60 weight parts of polyol residues of a polyether triol with a molecular weight of about 1000 Da per 100 weight parts total polyol residues, and (d) from about 5 weight parts to about 15 weight parts of polyol residues of a grafted copolymer triol comprising styrene and acrylonitrile per 100 weight parts total polyol residues.

Regardless of the polyol(s) used, the polyurethane of the present disclosure also comprises from about 15 weight parts to about 75 weight parts toluene diisocyanate (TDI) residues per 100 weight parts polyol residues. The TDI may comprise any of its various isomers in various relative proportions.

In one embodiment, the polyurethane comprises (a) from about 19 weight parts to about 40 weight parts of 2,4-TDI residues per 100 weight parts polyol residues, and (b) from about 6 weight parts to about 11 weight parts of 2,6-TDI residues per 100 weight parts polyol residues. Conveniently, the commonly commercially available formulations of 80/20 TDI (80 wt % 2,4-TDI and 20 wt % 2,6-TDI) and 65/35 TDI (65 wt % 2,4-TDI and 35 wt % 2,6-TDI) may be used.

In addition to the polyol residues and the TDI residues, the polyurethane may comprise one or more other materials.

In one embodiment, the viscoelastic foam layer may further comprise a cell-opening silicone additive. In a particular embodiment, the polyurethane may comprise from about 0.01 weight parts to about 0.5 weight parts of a cell-opening silicone additive per 100 weight parts total polyol residues.

Alternatively or in addition, the viscoelastic foam layer may further comprise a surfactant, such as a silicone surfactant formulated for use in a flexible slabstock foam. According to one embodiment, the surfactant may be Tegostab® B8220 (Evonik Industries, Essen, Germany). Regardless of the surfactant brand name and manufacturer, in one embodiment, the polyurethane may comprise from about 0.5 weight parts to about 1.5 weight parts of a silicone surfactant per 100 weight parts total polyol residues.

Alternatively or in addition, the viscoelastic foam layer may also comprise from about 0.1 weight parts to about 0.3 weight parts of a gel-catalyzing amine per 100 weight parts total polyol residues.

Alternatively or in addition, the viscoelastic foam layer may yet further comprise from about 0.1 weight parts to about 0.3 weight parts of a blow-catalyzing amine per 100 weight parts total polyol residues.

Alternatively or in addition, the viscoelastic foam layer may still also comprise from about 0.05 weight parts to about 0.12 weight parts of stannous octoate per 100 weight parts total polyol residues.

Alternatively or in addition, the viscoelastic foam layer may still further comprise from about 0.2 weight parts to about 1 weight part of chain modifier per 100 weight parts total polyol residues.

Alternatively or in addition, the viscoelastic foam layer may also comprise from about 1.5 weight parts to about 2.5 weight parts acetone per 100 weight parts total polyol residues.

Alternatively or in addition, the viscoelastic foam layer may yet also comprise from about 2 weight parts to about 3 weight parts water per 100 weight parts total polyol residues.

The polyols, the TDI, and the other components may be combined under particular conditions, including, but not limited to, the examples described below, to form the viscoelastic foam layer such that the viscoelastic foam layer: has a density less than or equal to 2 pounds/cubic foot (0.032 g/cm³), has an air flow greater than or equal to 2.5 CFM (0.07 m³/min), has a recovery time greater than or equal to 4 seconds, has an indentation force deflection (IFD) less than or equal to 10 pounds/square foot (478.8 Pa), and/or has a height loss less than or equal to 10% after prolonged compression of 90% of an original height. The person of ordinary skill in the art would not expect a viscoelastic foam to both comprise TDI in the proportions set forth above and have all the characteristics set forth in this paragraph. Specifically, the person of ordinary skill in the art would not expect a viscoelastic foam comprising TDI at a density than or equal to 2 pounds/cubic foot (0.032 g/cm³) to have both an air flow greater than or equal to 2.5 CFM (0.07 m³/min) and a recovery time greater than or equal to 4 seconds. Also, the person of ordinary skill in the art would not expect a viscoelastic foam comprising TDI at a density than or equal to 2 pounds/cubic foot (0.032 g/cm³) to have both an IFD less than or equal to 10 pounds/square foot (478.8 Pa), and a height loss less than or equal to 10% after prolonged compression of 90% of an original height.

Though not to be bound by theory, the viscoelastic foam layer of the present disclosure may have an irregular cell structure. Further not to be bound by theory, this irregular cell structure may be imparted by use of a polyol with a relatively high molecular weight, e.g., 4.6 kDa, and a high ethylene oxide content.

As an alternative or in addition to the various materials described above, in one embodiment, the viscoelastic foam layer may further comprise from about 0.0001 weight parts to about 30 weight parts of ionic copper particles per 100 weight parts total polyol residues. Though not to be bound by theory, ionic copper particles, such as those commercially available in various formations provided by Capron Inc., Richmond, Va., may impart antibacterial, antifungal, antimicrobial, and/or antiviral properties to the viscoelastic foam layer.

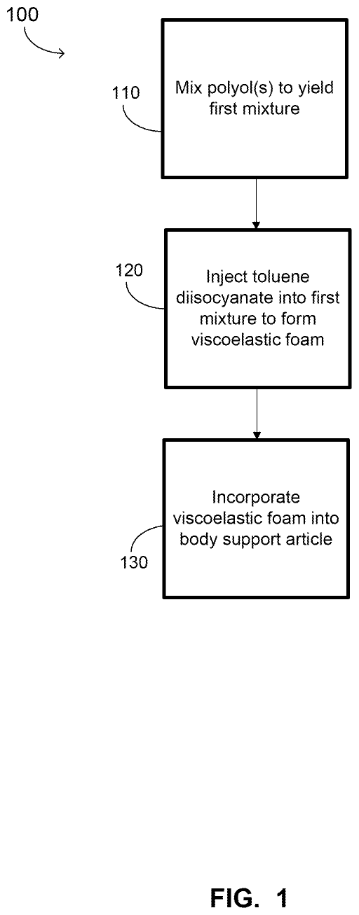

The viscoelastic foam layer may be manufactured using any known technique. FIG. 1 is a flowchart of a method 100, in accordance with embodiments herein. The method 100 comprises mixing (block 110), at a temperature from about 60° F. (15° C.) to about 80° F. (27° C.), a mixer head pressure from about 8 psi (55 kPa) to about 15 psi (104 kPa), and a shear mixing velocity from about 2500 rpm to about 5000 rpm, at least one polyol to yield a first mixture.

The mixing (block 110) may comprise mixing from about 5 weight parts to about 25 weight parts of polyol residues of a polyether triol with a molecular weight of about 4600 Da and a high ethylene oxide content per 100 weight parts total polyol residues, and from about 5 weight parts to about 15 weight parts of polyol residues of a grafted copolymer triol comprising styrene and acrylonitrile per 100 weight parts total polyol residues.

In embodiments, the mixing (block 110) may further comprise mixing from about 0.01 weight parts to about 0.5 weight parts of a cell-opening silicone additive per 100 weight parts total polyols.

In one embodiment, the mixing (block 110) may further comprise mixing from about 5 weight parts to about 15 weight parts of a glycerin-initiate heteropolymer triol with a molecular weight of about 3100 Da per 100 weight parts total polyols, from about 5 weight parts to about 60 weight parts of a polyether triol with a molecular weight of about 1000 Da per 100 weight parts total polyols, from about 0.5 weight parts to about 1.5 weight parts of a silicone surfactant per 100 weight parts total polyols, from about 0.1 weight parts to about 0.3 weight parts of a gel-catalyzing amine per 100 weight parts total polyols, from about 0.1 weight parts to about 0.3 weight parts of a blow-catalyzing amine per 100 weight parts total polyols, from about 0.05 weight parts to about 0.12 weight parts of stannous octoate per 100 weight parts total polyols, from about 0.2 weight parts to about 1 weight part of chain modifier per 100 weight parts total polyols, from about 1.5 weight parts to about 2.5 weight parts acetone per 100 weight parts total polyols, and from about 2 weight parts to about 3 weight parts water per 100 weight parts total polyols.

In one embodiment, the mixing (block 110) may further comprise mixing from about 0.0001 weight parts to about 30 weight parts of ionic copper particles per 100 weight parts total polyol residues.

The various polyols, silicones, ionic copper particles, etc. may be as described above.

The method 100 also comprises injecting (at block 120) into the first mixture, at a pressure from about 300 psi (2.06 MPa) to about 500 psi (3.45 MPa), from about 15 weight parts to about 75 weight parts toluene diisocyanate (TDI) per 100 weight parts polyol, to form a viscoelastic foam layer. The TDI may be as described above. In embodiments, the injecting (block 120) may comprise injecting from about 19 weight parts to about 40 weight parts of 2,4-TDI per 100 weight parts total polyols, and from about 6 weight parts to about 11 weight parts of 2,6-TDI per 100 weight parts total polyols.

The viscoelastic foam layer formed by injection (block 120) may have a density less than or equal to 2 pounds/cubic foot (0.032 g/cm³), an air flow greater than or equal to 2.5 CFM (0.07 m³/min), a recovery time greater than or equal to 4 seconds, an indentation force deflection (IFD) less than or equal to 10 pounds/square foot (478.8 Pa), and/or a height loss less than or equal to 10% after prolonged compression of 90% of an original height.

The viscoelastic foam layer generated by injecting (block 120) may be used in any of a number of applications. In one embodiment, the method 100 may further comprise incorporating (block 130) the viscoelastic foam layer into a body support article.

Body support articles refer to articles intended to at least partially bear the weight of at least a portion of a human or animal body, thereby providing comfort to the human or animal. In one embodiment, the body support article is a mattress, a mattress topper, a pillow, or a cushion.

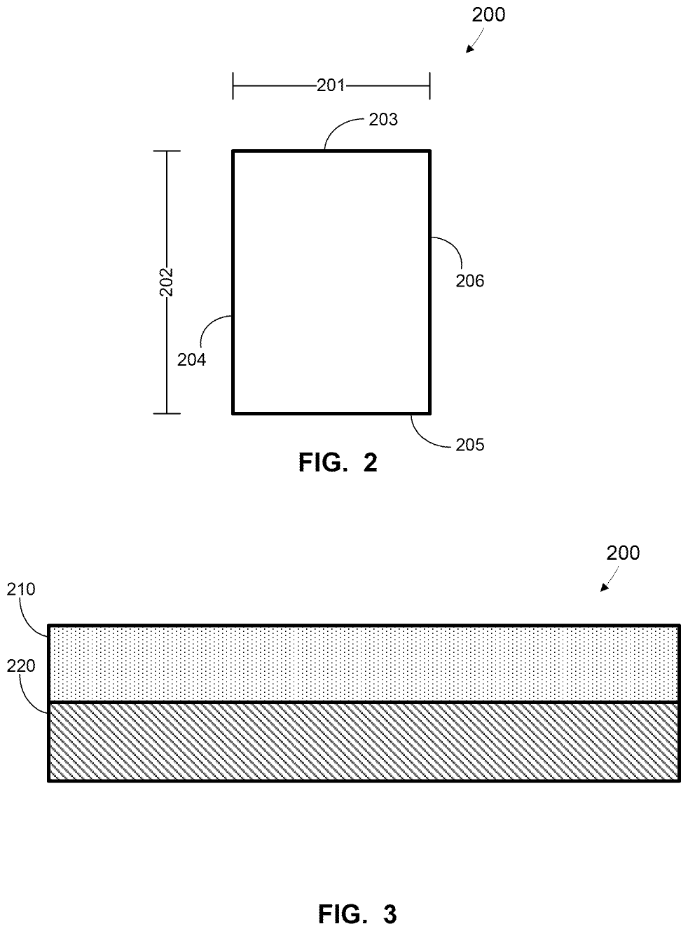

The body support article comprises a viscoelastic foam layer as described above and may contain one or more other layers. An exemplary body support article will be described with reference to FIG. 2 and FIG. 3.

Turning to FIG. 2, a stylized top view of a mattress 200, in accordance with embodiments herein, is illustrated. The mattress 200 has a generally rectangular profile in top view, with opposed shorter sides 203, 205 each having a dimension 201, and opposed longer sides 204, 206 each having a dimension 202. Typically, the shorter sides 203, 205 provide the head and foot ends, respectively, of the mattress 200, and the longer sides 204, 206 provide the sides of the mattress 200.

FIG. 3 illustrates a stylized side view of the mattress 200, in accordance with embodiments herein. The side view shows the longer side 204.

In the depicted embodiment, the mattress 200 comprises a viscoelastic foam layer 210 disposed directly above a base layer 220. The base layer 220 may comprise a viscoelastic foam, a non-viscoelastic foam, or a polyurethane foam, among other materials. In one embodiment, the base layer 220 comprises a non-viscoelastic foam.

The base layer 220 and the viscoelastic foam layer 210 may be bonded together by any suitable adhesive. The base layer 220 and the viscoelastic foam layer 210 may be assembled using any process and/or equipment known in the art.

The embodiment shown in FIG. 3 is merely exemplary of a mattress 200 that may comprise a viscoelastic foam layer 210 in accordance with embodiments herein. In other embodiments, the viscoelastic foam layer 210 may be the only layer of a mattress, or the mattress may further comprise layers in addition to the viscoelastic foam layer 210 and the base layer 220. All such variations in a mattress 200 will readily occur to the person of ordinary skill in the art having the benefit of the present disclosure and need not be described further.

The embodiment shown in FIG. 2 is merely exemplary of a body support article that may comprise a viscoelastic foam layer 210 in accordance with embodiments herein. The person of ordinary skill in the art having the benefit of the present disclosure could readily prepare a mattress topper, a pillow, a cushion, or the like.

For the avoidance of doubt, and in accordance with practice before the United States Patent and Trademark Office, none of the present figures are to scale.

The particular embodiments disclosed above are illustrative only, as the disclosure may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is, therefore, evident that the particular embodiments disclosed above may be altered or modified and all such variations are considered within the scope and spirit of the disclosure. Accordingly, the protection sought herein is as set forth in the claims below.

What is claimed is:

1. A viscoelastic foam layer, comprising:
a polyurethane, comprising toluene diisocyanate (TDI) residues and polyol residues.

2. The viscoelastic foam layer of claim 1 wherein the polyurethane comprises:
from about 15 weight parts to about 75 weight parts toluene diisocyanate (TDI) residues per 100 weight parts polyol residues; and
wherein the viscoelastic foam layer:
has a density less than or equal to 2 pounds/cubic foot (0.032 g/cm³), has an air flow greater than or equal to 2.5 CFM (0.07 m³/min),
has a recovery time greater than or equal to 4 seconds,
has an indentation force deflection (IFD) less than or equal to 10 pounds square foot (478.8 Pa),
has a height loss less than or equal to 10% after prolonged compression of 90% of an original height.

3. The viscoelastic foam layer of claim 2, wherein the polyurethane comprises:
from about 16 weight parts to about 40 weight parts of 2,4-TDI residues per 100 weight parts polyol residues, and
from about 6 weight parts to about 11 weight parts of 2,6-TDI residues per 100 weight parts polyol residues;

4. The viscoelastic foam layer of claim 3, wherein the polyurethane comprises:
from about 5 weight parts to about 25 weight parts of polyol residues of a polyether triol with a molecular weight of about 4600 Da and a high ethylene oxide content per 100 weight parts total polyol residues, and
from about 5 weight parts to about 15 weight parts of polyol residues of a grafted copolymer triol comprising styrene and acrylonitrile per 100 weight parts total polyol residues.

5. The viscoelastic foam layer of claim 3, wherein the polyurethane comprises:
from about 5 weight parts to about 15 weight parts of polyol residues of a glycerin-initiate heteropolymer triol with a molecular weight of about 3100 Da per 100 weight parts total polyol residues,
from about 5 weight parts to about 25 weight parts of polyol residues of a polyether triol with a molecular weight of about 4600 Da and a high ethylene oxide content per 100 weight parts total polyol residues,
from about 5 weight parts to about 60 weight parts of polyol residues of a polyether triol with a molecular weight of about 1000 Da per 100 weight parts total polyol residues,
from about 5 weight parts to about 15 weight parts of polyol residues of a grafted copolymer triol comprising styrene and acrylonitrile per 100 weight parts total polyol residues,
from about 0.5 weight parts to about 1.5 weight parts of a silicone surfactant per 100 weight parts total polyol residues,
from about 0.01 weight parts to about 0.5 weight parts of a cell-opening silicone additive per 100 weight parts total polyol residues,
from about 0.1 weight parts to about 0.3 weight parts of a gel-catalyzing amine per 100 weight parts total polyol residues,
from about 0.1 weight parts to about 0.3 weight parts of a blow-catalyzing amine per 100 weight parts total polyol residues,
from about 0.05 weight parts to about 0.12 weight parts of stannous octoate per 100 weight parts total polyol residues,
from about 0.2 weight parts to about 1 weight part of chain modifier per 100 weight parts total polyol residues,
from about 1.5 weight parts to about 2.5 weight parts acetone per 100 weight parts total polyol residues, and
from about 2 weight parts to about 3 weight parts water per 100 weight parts total polyol residues.

6. The viscoelastic foam layer of claim 1, wherein the viscoelastic foam layer has an irregular cell structure.

7. A body support article, comprising:
a viscoelastic foam layer, wherein the viscoelastic foam layer:
has a density less than or equal to 2 pounds/cubic foot (0.032 g/cm³),
has an air flow greater than or equal to 2.5 CFM (0.07 m³/min),
has a recovery time greater than or equal to 4 seconds,
has an indentation force deflection (IFD) less than or equal to 10 pounds/square foot (478.8 Pa),
has a height loss less than or equal to 10% after prolonged compression of 90% of an original height, and
comprises a polyurethane comprising:
from about 15 weight parts to about 75 weight parts toluene diisocyanate (TDI) residues per 100 weight parts polyol residues.

8. The body support article of claim 7, wherein the polyurethane comprises:
from about 19 weight parts to about 40 weight parts of 2,4-TDI residues per 100 weight parts polyol residues, and
from about 6 weight parts to about 11 weight parts of 2,6-TDI residues per 100 weight parts polyol residues.

9. The body support article of claim 8, wherein the polyol residues comprise:
from about 5 weight parts to about 25 weight parts of polyol residues of a polyether triol with a molecular weight of about 4600 Da and a high ethylene oxide content per 100 weight parts total polyol residues, and
from about 5 weight parts to about 15 weight parts of polyol residues of a grafted copolymer triol comprising styrene and acrylonitrile per 100 weight parts total polyol residues.

10. The body support article of claim 8, wherein the polyurethane comprises:
from about 5 weight parts to about 15 weight parts of polyol residues of a glycerin-initiate heteropolymer triol with a molecular weight of about 3100 Da per 100 weight parts total polyol residues,
from about 5 weight parts to about 25 weight parts of polyol residues of a polyether triol with a molecular weight of about 4600 Da and a high ethylene oxide content per 100 weight parts total polyol residues,
from about 5 weight parts to about 60 weight parts of polyol residues of a polyether triol with a molecular weight of about 1000 Da per 100 weight parts total polyol residues,
from about 5 weight parts to about 15 weight parts of polyol residues of a grafted copolymer triol comprising styrene and acrylonitrile per 100 weight parts total polyol residues,
from about 0.5 weight parts to about 1.5 weight parts of a silicone surfactant per 100 weight parts total polyol residues,
from about 0.01 weight parts to about 0.5 weight parts of a cell-opening silicone additive per 100 weight parts total polyol residues,
from about 0.1 weight parts to about 0.3 weight parts of a gel-catalyzing amine per 100 weight parts total polyol residues,
from about 0.1 weight parts to about 0.3 weight parts of a blow-catalyzing amine per 100 weight parts total polyol residues,
from about 0.05 weight parts to about 0.12 weight parts of stannous octoate per 100 weight parts total polyol residues,
from about 0.2 weight parts to about 1 weight part of chain modifier per 100 weight parts total polyol residues,
from about 1.5 weight parts to about 2.5 weight parts acetone per 100 weight parts total polyol residues, and
from about 2 weight parts to about 3 weight parts water per 100 weight parts total polyol residues.

11. The body support article of claim 8, wherein the viscoelastic foam layer has an irregular cell structure.

12. The body support article of claim 8, wherein the body support article is a mattress, a mattress topper, a pillow, or a cushion.

13. A method, comprising:
mixing, at a temperature from about 60° F. (15° C.) to about 80° F. (27° C.), a mixer head pressure from about 8 psi (55 kPa) to about 15 psi (104 kPa), and a shear mixing velocity from about 2500 rpm to about 5000 rpm, at least one polyol to yield a first mixture;
injecting into the first mixture, at a pressure from about 300 psi (2.06 MPa) to about 500 psi (3.45 MPa), from about 15 weight parts to about 75 weight parts toluene diisocyanate (TDI) residues per 100 weight parts polyol residues, to form a viscoelastic foam layer.

14. The method of claim 13, wherein the injecting comprises injecting from about 19 weight parts to about 40 weight parts of 2,4-TDI per 100 weight parts total polyols, and from about 6 weight parts to about 11 weight parts of 2,6-TDI per 100 weight parts total polyols.

15. The method of claim 14, wherein the mixing comprises mixing from about 5 weight parts to about 25 weight parts of polyol residues of a polyether triol with a molecular weight of about 4600 Da and a high ethylene oxide content per 100 weight parts total polyol residues, and from about 5 weight parts to about 15 weight parts of polyol residues of a grafted copolymer triol comprising styrene and acrylonitrile per 100 weight parts total polyol residues.

16. The method of claim 13, wherein the mixing further comprises mixing from about 0.01 weight parts to about 0.5 weight parts of a cell-opening silicone additive per 100 weight parts total polyols.

17. The method of claim 13, wherein the mixing further comprises mixing:
from about 5 weight parts to about 15 weight parts of a glycerin-initiate heteropolymer triol with a molecular weight of about 3100 Da per 100 weight parts total polyols,
from about 5 weight parts to about 60 weight parts of a polyether triol with a molecular weight of about 1000 Da per 100 weight parts total polyols,
from about 0.5 weight parts to about 1.5 weight parts of a silicone surfactant per 100 weight parts total polyols,
from about 0.1 weight parts to about 0.3 weight parts of a gel-catalyzing amine per 100 weight parts total polyols,
from about 0.1 weight parts to about 0.3 weight parts of a blow-catalyzing amine per 100 weight parts total polyols,
from about 0.05 weight parts to about 0.12 weight parts of stannous octoate per 100 weight parts total polyols,
from about 0.2 weight parts to about 1 weight part of chain modifier per 100 weight parts total polyols,
from about 1.5 weight parts to about 2.5 weight parts acetone per 100 weight parts total polyols, and
from about 2 weight parts to about 3 weight parts water per 100 weight parts total polyols.

18. The method of claim 13, wherein the injecting produces a viscoelastic foam layer having:
a density less than or equal to 2 pounds/cubic foot (0.032 g/cm³),
an air flow greater than or equal to 2.5 CFM (0.07 m³/min),
a recovery time greater than or equal to 4 seconds,
an indentation force deflection (IFD) less than or equal to 10 pounds/square foot (478.8 Pa), and
a height loss less than or equal to 10% after prolonged compression of 90% of an original height.

19. The method of claim 13, further comprising:
incorporating the viscoelastic foam layer into a body support article.

20. The method of claim 19, wherein the body support article is a mattress, a mattress topper, a pillow, or a cushion.
